(19) United States
(12) Patent Application Publication
(10) Pub. No.: US 2019/0130066 A1
(43) Pub. Date: May 2, 2019

(54) HEALTH TREND ANALYSIS AND INSPECTION

(71) Applicant: Colossio, Inc., Chicago, IL (US)

(72) Inventor: Joseph A. Jaroch, Chicago, IL (US)

(21) Appl. No.: 15/795,544

(22) Filed: Oct. 27, 2017

(51) Int. Cl. G06F 19/00; G06F 17/30

(52) U.S. Cl. CPC G06F 19/322; G06F 19/321; G06F 19/3418; G06F 17/30864; G06F 19/345

(57) ABSTRACT

Methods for providing health trend analysis and inspection are provided. In one aspect, a method includes detecting a presence of a user. The method also includes determining that a threshold time period has elapsed. The method also includes retrieving, from a server, a health query customized for the user based on a patient data store associated with the user. The method also includes prompting the user to provide a response to the health query. The method also includes storing the response to the health query and an associated timestamp in a secure package. The method also includes uploading the secure package to the server via an available network connection to cause the server to store the contents of the secure package and perform an action based on one or more analysis algorithms applied on the patient data store associated with the user. Systems and machine-readable media are also provided.

### TECHNICAL FIELD

The present disclosure generally relates to healthcare, and more specifically relates to health trend analysis and inspection.

### BACKGROUND

Traditional approaches to healthcare are failing to meet the needs of today's patients. After a doctor visit, patients are scheduled for checkups that occur several months later. Patients often dread these checkup visits, as patients feel that they are being judged and criticized for any negative health outcomes that may be discovered. Further, the checkup visits are often inconvenient for the patient, as conforming to doctor schedules often means the patient must miss work, school, or other obligations. Even if the patient manages to attend the checkup visit, various factors may cause both the patient and the doctor to feel limited in their ability to engage in an honest and comprehensive discussion of the patient's health issues.

The description provided in the background section should not be assumed to be prior art merely because it is mentioned in or associated with the background section. The background section may include information that describes one or more aspects of the subject technology.

### SUMMARY

The disclosed system provides health trend analysis and inspection for improving resource utilization of electronic healthcare systems. An application may be installed on one or more devices owned by a user. On a periodic basis across the user's devices and when a presence of the user is detected, the application prompts the user to respond to a health query. The health query is based on a patient data store associated with the user, and may solicit an open ended wellness assessment rather than a multiple choice answer. The health query may also request that the user capture a photograph or video of a particular body part or area. Over time, responses to these health queries may be collected, categorized, and processed using analysis algorithms, which may be also be updated over time. Actions may be performed based on the results of the analysis, such as alerting a doctor or another healthcare provider.

According to certain aspects of the present disclosure, a computer-implemented method is provided. The method includes detecting a presence of a user. The method also includes determining that a threshold time period has elapsed. The method also includes retrieving, from a server, a health query customized for the user based on a patient data store associated with the user. The method also includes prompting the user to provide a response to the health query. The method also includes storing the response to the health query and an associated timestamp in a secure package. The method also includes uploading the secure package to the server via an available network connection to cause the server to: store the response to the health query and the associated timestamp in the patient data store associated with the user; and perform an action based on one or more analysis algorithms applied on the patient data store associated with the user.

According to certain aspects of the present disclosure, a system is provided including a memory, and a processor configured to execute instructions. When executed, the instructions cause the processor to detect a presence of a user. The instructions also cause the processor to query a server for a most recent health query response time from one or more devices associated with the user. The instructions also cause the processor to determine that an elapsed time from the most recent health query response time exceeds a threshold time period. The instructions also cause the processor to retrieve, from a server, a health query customized for the user based on a patient data store associated with the user. The instructions also cause the processor to prompt the user to provide a response to the health query. The instructions also cause the processor to receive user input including one of speech, text, or handwriting. The instructions also cause the processor to parse the user input to generate the response to the health query. The instructions also cause the processor to store the response to the health query and an associated timestamp in a secure package. The instructions also cause the processor to upload the secure package to the server via an available network connection to cause the server to: store the response to the health query and the associated timestamp in the patient data store associated with the user; and perform an action based on one or more analysis algorithms applied on the patient data store associated with the user.

According to certain aspects of the present disclosure, a non-transitory machine-readable storage medium is provided that includes machine-readable instructions for causing a processor to execute a method detecting a presence of a user. The method includes querying a server for a most recent health query response time from one or more devices associated with the user. The method includes determining that an elapsed time from the most recent health query response time exceeds a threshold time period. The method includes retrieving, from a server, a health query customized for the user based on a patient data store associated with the user. The method includes prompting the user to provide a response to the health query. The method includes receiving user input including one of speech, text, or handwriting. The method includes parsing the user input to generate the response to the health query. The method includes storing the response to the health query and an associated timestamp in a secure package. The method includes uploading the secure package to the server via an available network connection to cause the server to: store the response to the health query and the associated timestamp in the patient data store associated with the user; determine that an updated diagnostic profile is available for one or more analysis algorithms; update the one or more analysis algorithms based on the updated diagnostic profile; and perform an action based on the one or more analysis algorithms applied on the patient data store associated with the user.

According to certain aspects of the present disclosure, a system is provided. The system includes a means for detecting a presence of a user. The system includes a means for determining that a threshold time period has elapsed. The system includes a means for retrieving, from a server, a health query customized for the user based on a patient data store associated with the user. The system includes a means for prompting the user to provide a response to the health query, for storing the response to the health query and an associated timestamp in a secure package, and for uploading the secure package to the server via an available network connection to cause the server to: store the response to the health query and the associated timestamp in the patient data store associated with the user; and perform an action based on one or more analysis algorithms applied on the patient data store associated with the user.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate aspects of the subject technology, and together with the description serve to explain the principles of the subject technology. In the drawings:

FIG. 1 illustrates an example architecture for providing health trend analysis and inspection.

FIG. 2 is a block diagram illustrating the example clients and servers from the architecture of FIG. 1 according to certain aspects of the disclosure.

FIG. 3 illustrates an example process for providing health trend analysis and inspection using the example client of FIG. 2.

FIG. 4A illustrates an example user interface for prompting a user to provide a response to a health query on a computing device.

FIG. 4B illustrates an example user interface for prompting a user to provide a response to a health query on a mobile device.

FIG. 4C illustrates an example user interface for instructing a user to capture a body area of the user via an imaging device.

FIG. 4D illustrates an example notification alert issued after performing one or more analysis algorithms on a patient data store.

FIG. 5 is a block diagram illustrating an example computer system with which the clients and servers of FIG. 2 can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

### General Overview

Healthcare providers have embraced electronic health (“E-health”) initiatives to encourage more frequent communication and interaction between patients and healthcare providers. However, present E-health approaches are still in their infancy and depend primarily on real-time remote presence conversations between a patient and a doctor. Since a doctor can only attend to one patient at a time, the patient is often directed to a tele-doctor instead of the patient's primary care doctor. Since the tele-doctor does not have the same personal relationships, patient information, and medical knowledge as the patient's primary care doctor, the quality of patient care may be compromised.

The disclosed system provides a way to track health and wellness in a non-invasive manner to encourage communication between patients and healthcare providers. Healthcare providers may provide a health tracking application that is installed on computing devices of the patient, such as a personal computer or a smartphone. Periodically, the application may prompt the user with a health query that is tailored to the patient according to a patient data store associated with the patient. Health queries may be posed to the patient in an open ended question format, rather than a rigid multiple choice or yes/no format. Responses to the health queries can be collected and categorized over time in the patient data store, and analysis algorithms may be applied to the patient data store to further customize the health queries for the particular patient. The analysis algorithms may also be used to trigger actions such as providing an alert notification to a healthcare professional, for example a primary care doctor of the patient.

In this manner, the personalized and open ended health queries may help to make the patient feel more invested and participatory in a treatment plan. Since the patient provides responses to an application rather than directly to a doctor, the patient may be freed of “doctor visit anxiety” and be more receptive to providing an honest self-assessment of wellness. In this manner, E-health infrastructure is utilized in an efficient manner by providing detailed patient-reported wellness over time without needing to schedule significant doctor facetime or utilize tele-doctors that may be unable to match the level of care provided by a primary care doctor.

The disclosed system addresses a technical problem tied to computer technology and arising in the realm of computer networks, namely the technical problem of improving resource utilization of E-health systems. The disclosed system solves this technical problem by collecting patient reported self-assessment responses on a periodic basis, rather than scheduling inconvenient and inflexible remote presence meetings. The responses can be gathered over time into a patient data store for remote analysis. In this manner, analysis algorithms and/or diagnostic parameters may be readily updated as new research and methodologies become available. Alerts to healthcare professionals may provide patient responses in a graph or plot over time, enabling the healthcare professional to identify inflection points in the treatment plan and to make adjustments accordingly.

Although certain examples provided herein may describe a user's diagnostic data being stored in memory, each user must grant explicit permission for such user information to be stored. The explicit permission may be granted using privacy controls integrated into the disclosed system. If requested user information includes demographic information, then the demographic information is aggregated on a group basis and not by individual user. Each user is provided notice that such user information will be stored with such explicit consent, and each user may at any time end having the user information stored, and may delete the stored user information. The stored user information may be encrypted to protect user security.

The user can at any time delete the user information from memory and/or opt out of having the user information stored in memory. Additionally, the user can, at any time, adjust appropriate privacy settings to selectively limit the types of user information stored in memory, or select the memory in which the user information is stored (e.g., locally on the user's device as opposed to remotely on a server). In many examples, the user information does not include and/or share the specific identification of the user (e.g., the user's name) unless otherwise specifically provided or directed by the user.

### Example System Architecture

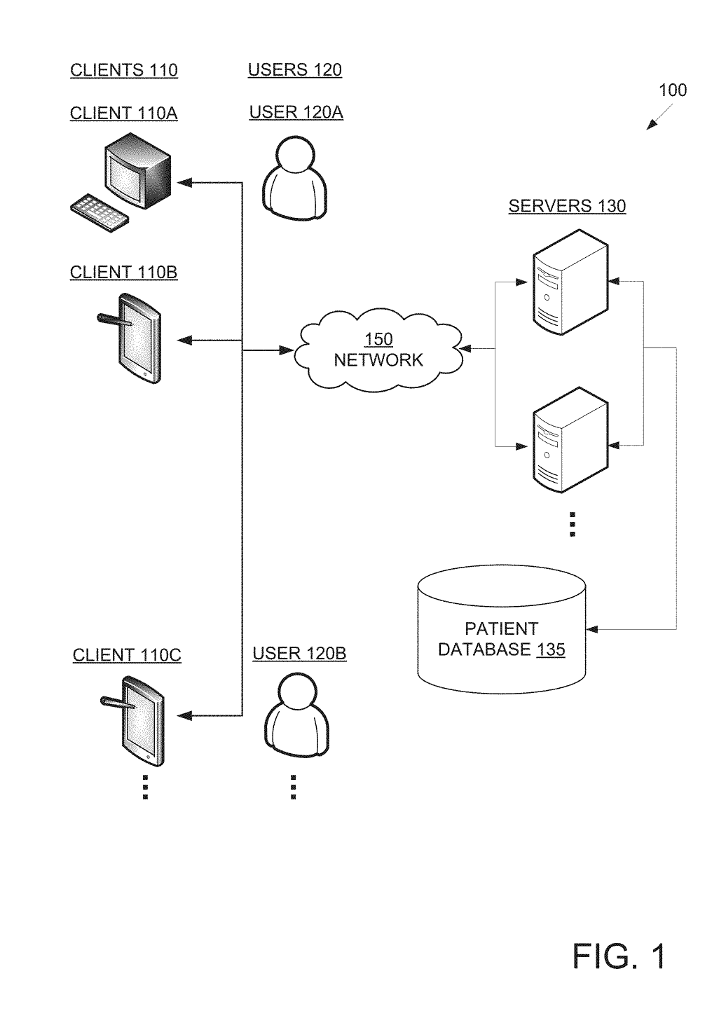

FIG. 1 illustrates an example architecture 100 for providing health trend analysis and inspection. The architecture 100 includes clients 110 and servers 130 connected over a network 150. Servers 130 may connect and communicate with patient database 135, for example over a local intranet. In some aspects of the subject technology, servers 130 may instead connect to patient database 135 over network 150. Users 120 may interact with respective clients 110.

The clients 110 may each execute a health tracking application for an associated user. Thus, client 110A and client 110B may track the health of user 120A, whereas client 110C may track the health of user 120B. A particular device associated with a user may detect the presence of the user before conducting a health query that is periodic across all associated user devices. The responses to the periodic health queries may be securely packaged and sent over network 150 for storing in an associated patient data store within patient database 135. Patient database 135 may store data in an encrypted format to protect from unauthorized access.

The clients 110 can be any device having an appropriate processor, memory, and communications capability for executing the health tracking application and sending the secure packages. The clients 110 to which the servers 130 are connected over the network 150 can be, for example, desktop computers, mobile computers, tablet computers (e.g., including e-book readers), mobile devices (e.g., a smartphone or PDA), set top boxes (e.g., for a television), video game consoles, or any other devices having appropriate processor, memory, and communications capabilities.

One of the many servers 130 is configured to host a data collection service. For the purposes of load balancing, multiple servers 130 can host the data collection service. In certain aspects, one or more of the servers 130 can be a cloud computing server of an infrastructure-as-a-service (IaaS), and be able to support a platform-as-a-service (PaaS) and software-as-a-service (SaaS) services.

The data collection service receives the secure packages from clients 110 and stores the user provided responses into associated patient data stores within patient database 135. As patient database 135 is updated, servers 130 may apply one or more analysis algorithms to the patient data stores within patient database 135 to customize further health queries and to perform actions, such as providing an alert notification to a healthcare professional.

The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

### Example System for Providing Health Trend Analysis and Inspection

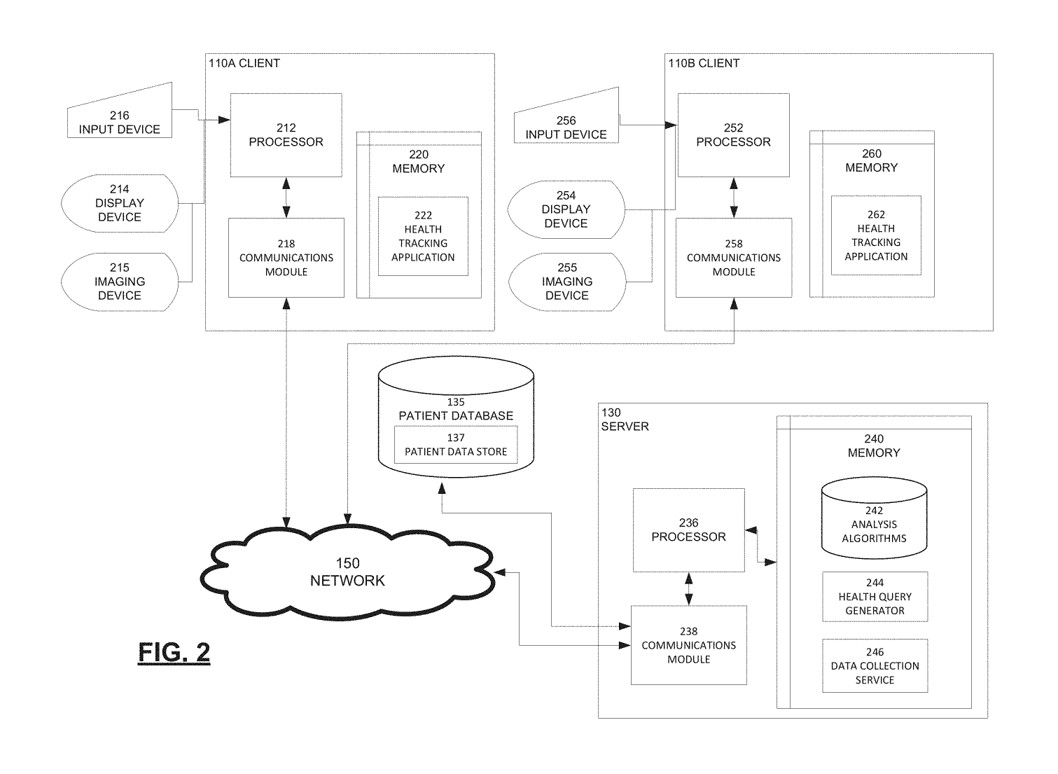

FIG. 2 is a block diagram illustrating an example server 130, client 110A and client 110B, and patient database 135 from the architecture of FIG. 1 according to certain aspects of the disclosure. The client 110A, client 110B, and server 130 are connected over the network 150 via respective communications modules 218, 258, and 238. The communications modules 218, 258, and 238 are configured to interface with the network 150 and to receive information, such as data, requests, responses, and commands to other devices on the network. The communications modules 218, 258, and 238 can be, for example, modems or Ethernet cards. Server 130 may also communicate with patient database 135 using communications module 238, for example, to issue database queries and add database records, for example into patient data store 137, which may be associated with a particular user, such as user 120A.

A desktop computer, or client 110A, is associated with user 120A and includes processor 212, communications module 218, and memory 220. The client 110A also includes an input device 216, such as a keyboard or mouse, a display device 214, such as a liquid crystal display (LCD), and an imaging device 215, such as a camera. The processor 212 of the client 110A is configured to execute instructions, such as instructions physically coded into the processor 212, instructions received from software in memory 220, or a combination of both. For example, the processor 212 of client 110A may execute health tracking application 222, corresponding to a desktop operating system version of the health tracking application, which may be downloaded from a healthcare provider website or an application storefront.

A mobile device, or client 110B, is associated with user 120A and includes processor 252, communications module 258, and memory 260. The client 110B may also include an input device 256, such as a keyboard or mouse, a display device 254, such as a LCD, and an imaging device 255, such as a camera. The processor 252 of the client 110B is configured to execute instructions, such as instructions physically coded into the processor 252, instructions received from software in memory 260, or a combination of both. For example, the processor 252 of client 110B may execute health tracking application 262, corresponding to a mobile phone version of the health tracking application, which may be downloaded from an application storefront.

The health tracking application 222 executing on processor 212 may first detect a presence of user 120A, for example by detecting a threshold level of activity from input device 216, or by detecting a presence of user 120A via imaging device 215. Once the presence of user 120A is established, the health tracking application 222 may query server 130 for a most recent health query response time across all devices associated with user 120A, or client 110A and client 110B in the example shown in FIG. 1 and FIG. 2. After determining that a threshold time period has elapsed since the most recent health query response, health tracking application 222 may retrieve a next health query from server 130. The health query may be displayed on display device 214 to prompt user 120A to answer the retrieved health query.

After receiving a response from user 120A, health tracking application 222 may securely package the response with an associated timestamp and send or upload the secure package via communications module 218 over network 150 to communications module 238 of server 130. The sending of the secure package may cause server 130 to store the response and the associated timestamp in a patient data store associated with user 120A in patient database 135. The sending of the secure package may also cause server 130 to perform an action based on applying analysis algorithms 242 on the patient data store associated with user 120A in patient database 135. While the above process is described with respect to health tracking application 222 executing on processor 212, health tracking application 262 executing on processor 252 may operate in a similar manner.

Although not specifically shown in FIG. 2, other users and associated clients may also be in communication with servers 130 over network 150. The other clients may include components similar to those shown in client 110A and client 110B in FIG. 2.

Server 130 includes processor 236, communications module 238, and memory 240, which includes analysis algorithms 242, health query generator 244, and data collection service 246. The processor 236 of the server 130 is configured to execute instructions, such as instructions physically coded into the processor 236, instructions received from software in memory 240, or a combination of both.

For example, the processor 236 of the server 130 executes instructions in health query generator 244 to generate a customized health query for a particular user based on a corresponding patient data store in patient database 135. The processor 236 of the server 130 also executes instructions in data collection service 246 to provide the customized health queries from health query generator 244 to a requesting client 110A or 110B. After client 110A or 110B presents the health query and receives a response from user 120A, data collection service 246 may receive a secure package containing the response and an associated timestamp. Data collection service 246 may then store the response and associated timestamp into a patient data store associated with user 120A within patient database 135. Data collection service 246 may also perform an action based on applying analysis algorithms 242 to the patient data store associated with user 120A within patient database 135.

In an aspect of the subject technology, the health query may include an instruction to capture a body area of user 120A via imaging device 215 or 255. For example, if user 120A is affected by a skin rash on his arm, then the health query may direct user 120A to provide a photo or video of the site of the skin rash on his arm. In another example, if user 120A had a recent surgery at a particular location, then the health query may direct user 120A to provide a photo or video of the surgery site to monitor the recovery from surgery.

In a further aspect of the subject technology, processor 212 is further configured to execute health tracking application 222 to upload a secure package to cause server 130 to, prior to performing an action based on applying analysis algorithms 242 on a patient data store associated with user 120A in patient database 135, determine that an updated diagnostic profile is available for analysis algorithms 242, and updating analysis algorithms 242 based on the updated diagnostic profile. For example, continuing with the skin rash example described above, if new medical research indicates that a rash with a particular hue indicates a particular medical condition, then this new research may be integrated into analysis algorithms 242, for example by updating a skin rash analysis algorithm in analysis algorithms 242 to detect the particular hue for detecting the particular medical condition.

The techniques described herein may be implemented as method(s) that are performed by physical computing device(s), as one or more non-transitory computer-readable storage media storing instructions which, when executed by computing device(s), cause performance of the method(s), or, as physical computing device(s) that are specially configured with a combination of hardware and software that causes performance of the method(s).

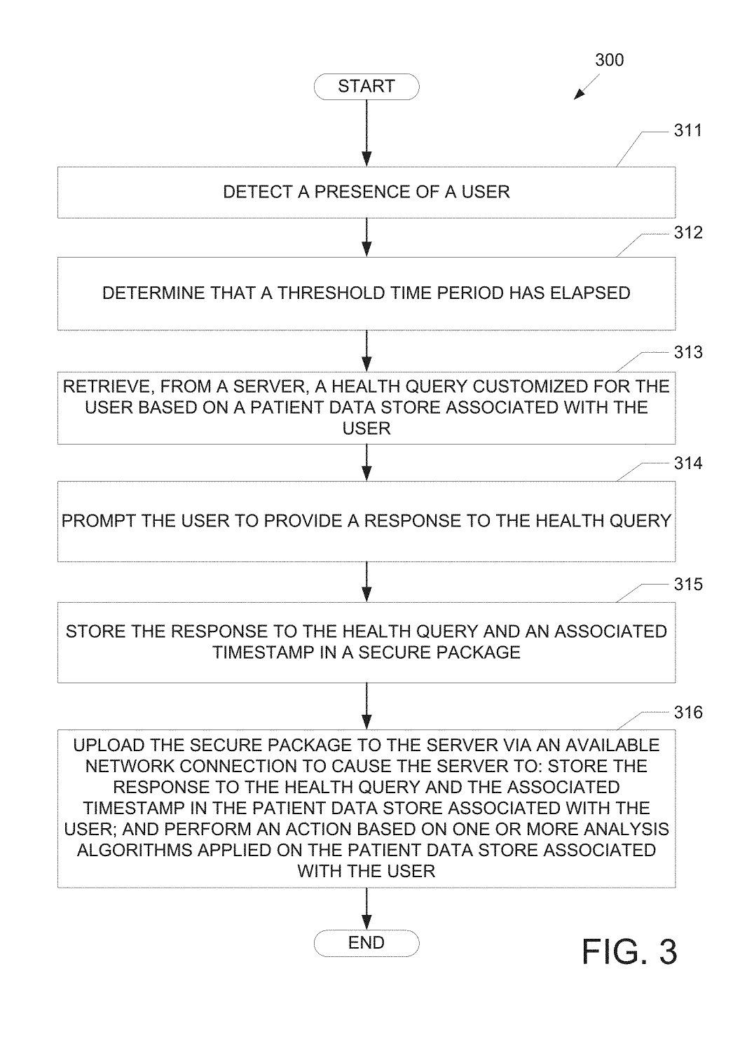

FIG. 3 illustrates an example process 300 for providing health trend analysis and inspection using the example client 110A of FIG. 2. While FIG. 3 is described with reference to FIG. 2, it should be noted that the process steps of FIG. 3 may be performed by other systems.

The process 300 begins by proceeding to step 311, where processor 212 detects a presence of user 120A. For example, imaging device 215 may comprise an integrated or peripheral camera that captures an image, and processor 212 may determine whether user 120A is present in the captured image by using facial recognition, human body shape recognition, or other methods. Imaging device 215 may include depth sensors and may detect that user 120A is within a certain distance proximity to client 110A to detect the presence of user 120A. Other sensors may be utilized, such as a microphone for detecting the voice of user 120A.

Alternatively, processor 212 may detect a presence of user 120A by detecting user activity from input device 216. For example, input device 216 may include a keyboard, mouse, or touchscreen. When a number of keystrokes, mouse movements, or touch inputs exceeds an idle threshold within a time period, for example an idle threshold of 10 inputs within a 10 second time period, then user 120A may be determined to be actively using client 110A and a presence of user 120A may be detected.

In step 312, processor 212 determines that a threshold time period has elapsed. This threshold time period indicates a frequency by which user 120A is to be prompted with health queries. The threshold time period may be set to 24 hours for daily health queries, for example. In contrast to checkup doctor visits that may be scheduled several months apart, the threshold time period can be set relatively frequently, for example not exceeding one week. The threshold time period may be set on a per user basis, and may be based on the particular medical conditions or patient history indicated in a patient data store associated with user 120A.

Since user 120A may be associated with multiple devices, or clients 110A and 110B, processor 212 may determine that the threshold time period has elapsed with respect to all devices associated with user 120A. Thus, processor 212 may determine a most recent health query response time across all devices associated with user 120A, for example by querying data collection service 246 of server 130. Data collection service 246 may request a most recent health query response time from each device associated with user 120A, or client 110A and client 110B, and the most recent health query response time can be selected.

In step 313, processor 212 retrieves, from server 130, a health query customized for user 120A based on patient data store 137 associated with user 120A. For example, if patient data store 137 includes a patient history that includes seasonal allergies and the current month is within an allergy season for a location associated with user 120A, the health query may include an inquiry on whether user 120A is suffering from allergy symptoms. In another example, if patient data store 137 includes an indication that user 120A had recently complained about a particular symptom, then the health query may include a follow up for that particular symptom.

In step 314, processor 212 prompts user 120A to provide a response to the retrieved health query. In one example, processor 212 may cause a notification or application window to be output to display device 214, wherein the notification or application window includes the retrieved health query. In another example, processor 212 may use voice synthesis to output the retrieved health query through a speaker or headphone. Prior to or concurrent with outputting the retrieved health query, an action such as an audible chime, vibration, or visual feedback may be provided to draw attention to the prompt.

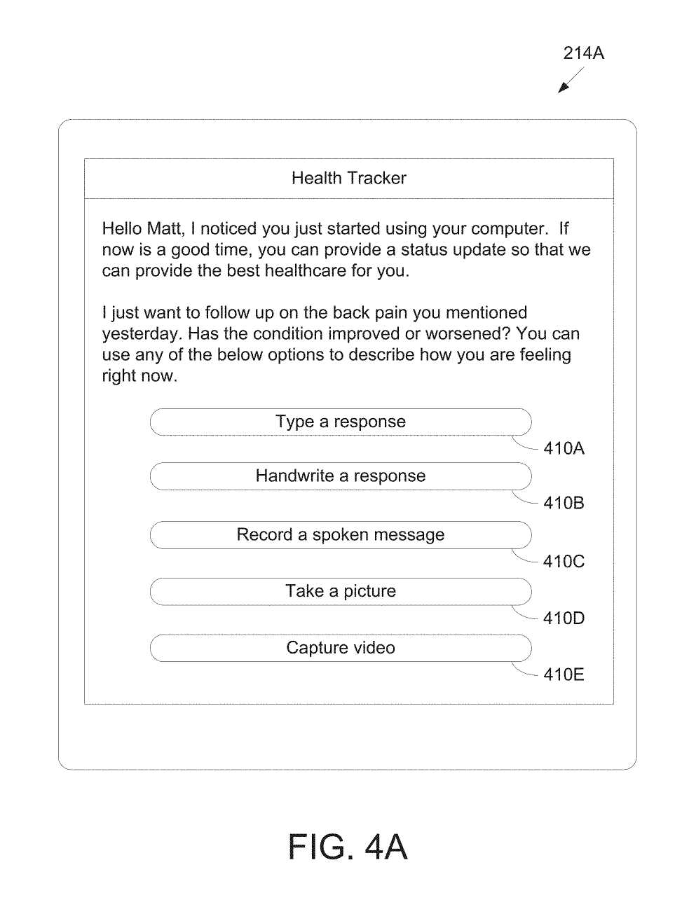

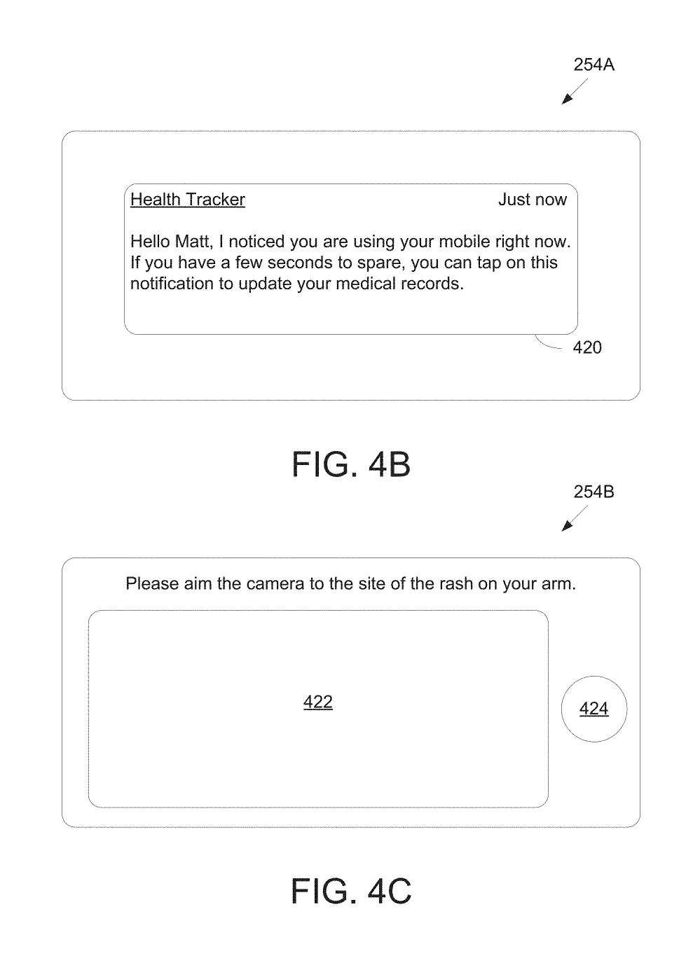

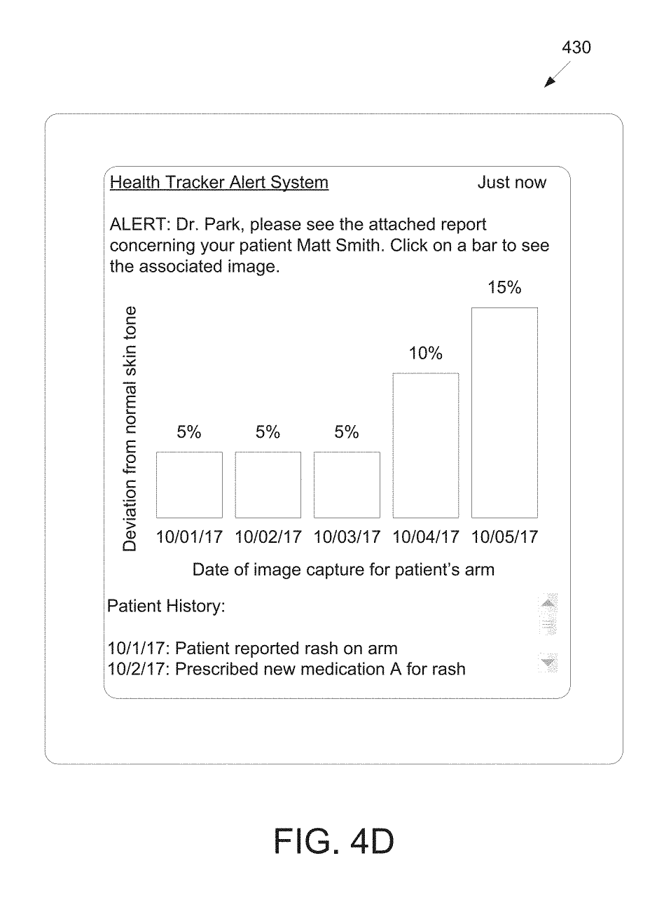

For example, FIG. 4A illustrates an example user interface for prompting user 120A to provide a response to a health query on client 110A. As shown in display device 214A, health tracking application 222 may first note that the presence of user 120A has been detected and may request that user 120A provide a response to the displayed health query, which has been customized for user 120A. For example, patient data store 137 may include prior responses from user 120A that were categorized into a “back pain” grouping. To follow up on the back pain issue, the health query asks whether the back pain has improved or worsened, and provides a variety of methods to provide the response, as indicated by button 410A, button 410B, button 410C, button 410D and button 410E.

Note that the health query is open ended, rather than prompting the user to answer a multiple-choice or yes/no query. A health query with a fixed selection of responses may be perceived as mechanical and impersonal. As a result, user 120A may ignore such inquiries or answer such queries in an automatic or routine fashion without giving much thought. On the other hand, when the health query is posed in an open ended fashion and is customized or personalized according to information in patient data store 137, user 120A may be more willing to provide a detailed and accurate self-diagnosis to improve healthcare outcomes.

As shown by buttons 410A-410E, user 120A has several options for responding to the health query, which may vary according to available input devices. For example, button 410A may be used to provide a typed response via input device 216 including a keyboard. Button 410B may be used to provide a typed response via display device 214 including a pen digitizer or touchscreen panel. Button 410C may be used to provide a spoken response via input device 216 including a microphone. Button 410D may be used to provide an image via imaging device 215 including a camera. Button 410E may be used to provide a video via imaging device 215 including a camera.

According to some aspects of the subject technology, the user input received after triggering button 410A-410E may be parsed to generate the response to the health query. For example, speech recognition may be used to convert spoken dialogue into editable text, handwriting recognition or optical character recognition (OCR) may be used to convert handwriting into editable text, or machine translation may be used to convert text from one language into another language.

According to some aspects of the subject technology, the response to the health query may be filtered to remove information that is duplicative or irrelevant to the health query. For example, if the health query requests user 120A to provide an image of a rash on his arm, then images retrieved by imaging device 215 may be filtered to remove irrelevant images, such as images that do not correspond to the arm of user 120A, or images that are not aligned with prior images of the arm provided by user 120A within patient data store 137. To assist in aligning the image, alignment instructions may be provided on display device 214 (e.g. “please aim the camera to the site of the rash on your arm”, “please pan up”, “please pan left”, “please zoom in”, “please zoom out”) and/or digital image processing may be utilized to align the image with previous images within patient data store 137.

Images retrieved by imaging device 215 may also be filtered to remove duplicative images, such as multiple images that correspond to the same viewpoint of the arm of user 120A when one or a few images are sufficient to answer the health query. In this manner, bandwidth utilization and storage footprint may be minimized. However, in some aspects of the subject technology, filtering may be reduced or bypassed when bandwidth and storage restraints are less of a concern.

Alternatively, process 300 may be carried out by processor 252 of client 110B. Steps 311, 312, and 313 may be carried out in a manner similar to as described above. In step 314, processor 252 may cause a notification to be output to display device 254, wherein the notification includes the retrieved health query.

For example, FIG. 4B illustrates an example user interface for prompting user 120A to provide a response to a health query on client 110B. As shown in display device 254A, health tracking application 262 may first note that the presence of user 120A has been detected and request that user 120A provide a response to a health query. Initially, notification 420 may provide a generic prompt such as “update your medical records” to preserve patient privacy, with further details shown after interaction by user 120A.

Thus, FIG. 4C illustrates an example user interface for instructing user 120A to capture a body area of the user via imaging device 255. Patient data store 137 may include prior responses from user 120A that include images categorized under an “arm rash” grouping. To follow up on the rash, as shown in display device 254B, the health query asks user 120A to capture the body area associated with the stored images in the “arm rash” grouping via imaging device 255.

As viewport 422 is updated from data from imaging device 255, instructions on display device 254B may be updated to instruct user 120A to align parameters of imaging device 255, or the camera, in a similar manner as the stored images in patient data store 137. The parameters may include camera angle, camera zoom, camera position, lighting, focus, and so forth. As discussed above, the instructions may include directions such as “zoom in”, “pan left”, and so forth. In some aspects of the subject technology, the images from viewport 422 may be processed using image processing techniques to more closely align the camera parameters with the stored images in patient data store 137.

User 120A may press camera button 424 to select an image from viewport 422 as the response. Alternatively, processor 252 may automatically determine a response by continuously capturing video and selecting one or more frames as the response, for example frames that have camera parameters most closely matching the stored images in patient data store 137. When processor 252 determines the response automatically, camera button 424 may end the automatic determination, or alternatively the automatic determination may trigger camera button 424 based on viewport 422 reaching a similarity threshold with the stored images. As discussed above, images or frames may be filtered to remove irrelevant or redundant responses.

Returning to client 110A, in step 315, processor 212 stores the response from step 314 and an associated timestamp in a secure package. For example, the secure package may be stored in memory 220, and may be encrypted for security. The timestamp may correspond to a present date and time, which may be retrieved from a local clock or from a remote time server. Depending on the method that user 120A chose to provide the response in step 314 and whether any processing or format conversion took place, the response within the secure package may be formatted as editable text, handwritten text, sounds, images, videos, or other formats.

In step 316, processor 212 uploads the secure package from step 315 to server 130 via network 150. In some situations, a network connection may be unavailable, for example if the user is travelling somewhere with poor reception. In this case, processor 212 may monitor network availability until a stable network connection can be established to upload the secure package to server 130.

Once server 130 receives the secure package, it may unpack and decrypt the secure package to access the response and associated timestamp. The response and associated timestamp may be stored in patient data store 137 associated with user 120A. As discussed above, patient database 135 may be encrypted to protect patient data store 137. The responses stored in patient data store 137 may be categorized into groups that indicate a particular health condition.

The categorization can be based on keyword matching or natural language processing. For example, the response from step 316 may be compared against a medical database using keyword or natural language processing to determine an appropriate grouping. Otherwise, if the categorization cannot be determined by matching to a database, then the categorization may be determined by examining previous responses in patient data store 137. For example, if patient data store 137 includes recent complaints about fevers and chills and the response received from step 316 indicates a complaint about a headache, the responses might be organized into a “cold” or “flu” grouping. In some aspects of the subject technology, machine language algorithms may be utilized to group responses into clusters based on similarity.

After storing the response and associated timestamp into patient data store 137, server 130 may apply analysis algorithms 242 to patient data store 137. Since patient data store 137 may potentially include a large amount of data concerning user 120A, analysis algorithms 242 may be limited to process data associated with the determined category for the received response. Analysis algorithms 242 may apply in an iterative fashion to the data points, or the responses in patient data store 137. Accordingly, analysis algorithms 242 may detect trends over time, such as changes to user sentiment, which can be used as a proxy for health and wellbeing.

While analysis algorithms 242 may focus on data stored in patient data store 137 for user 120A, analysis algorithms 242 may also consider larger trends for associated patient groups or demographics within patient database 135. Accordingly, patient data stores associated with other users, such as user 120B, may also be considered in the context of larger group trends when applying analysis algorithms 242 for user 120A. When such analysis is performed, the data may be considered in aggregate and not at the individual user level.

Since analysis algorithms 242 are applied on server 130, the analysis algorithms 242 can be easily updated without pushing an application update to health tracking application 222 or 262. Thus, prior to utilizing analysis algorithms 242, server 130 may check whether an updated diagnostic profile or updated diagnostic parameters are available for analysis algorithms 242, for example based on new and updated medical research. When updates are available, then analysis algorithms 242 can be updated based on the updated diagnostic profile to keep up to date. In this manner, updating and applying analysis algorithms 242 on server 130 reduces the risk of clients applying incorrect or outdated analysis algorithms.

After completion of analysis algorithms 242, a result may be provided, and server 130 may perform an action based on the result. For example, an alert may be sent to a healthcare professional such as a doctor when the result crosses a particular threshold. In another example, a notification may be sent back to client 110A or 110B, for example, to provide adjusted treatment instructions. In another example, a flag may be stored in patient data store 137, wherein the flag indicates a match to a particular diagnosis. A healthcare professional may review the flag and adjust treatment plans if necessary.

For example, FIG. 4D illustrates an example notification alert 430 issued after performing one or more analysis algorithms on patient data store 137. As shown in notification alert 430, analysis algorithms 242 performed an analysis on images stored in patient data store 137 regarding a rash on the arm of user 120A. As a result of analysis algorithms 242, a trend is observed from Oct. 4, 2017 where a deviation from normal skin tone for user 120A suddenly increases. A deviation exceeding a threshold of 10%, for example, may have triggered notification alert 430, as shown by the reading for Oct. 5, 2017. The doctor receiving notification alert 430 may interact with the graph to view the original images associated with the graphed data points that are stored in patient data store 137.

Other associated information from patient data store 137 may also be shown, such as a patient history. As shown in notification alert 430, a new “medication A” was prescribed to user 120A on Oct. 1, 2017. It may be known that side effects of “medication A” include breaking out in a rash, and that the side effects are delayed until 2-4 days. With this knowledge, the doctor may conclude that “medication A” worsened the rash on the arm for user 120A, and the doctor may adjust the treatment plan for user 120A by discontinuing “medication A” and prescribing an alternative medication or therapy.

In some aspects of the present technology, an optional monitoring layer may be enabled for health tracking application 222 or 262. This monitoring layer may track all interactions with client 110A or client 110B, such as social media communications, web searches, text messages, audio searches, and other interactions, with spaces or line breaks automatically inserted during pauses or focus changes to different windows or screen areas. In some at-risk patients such as elder care patients or children subject to bullying or other stressors, a trusted family member or guardian may enable this optional monitoring layer, which may provide the tracked interactions as responses to be stored in patient data store 137. Analysis algorithms 242 may use natural language parsing algorithms to determine trends in user sentiment based on the responses, which can be used to predict risky behavior. In this manner, at-risk patients who may not respond to health queries can still be monitored for risky behavior, and intervention actions can be carried out in response.

### Hardware Overview

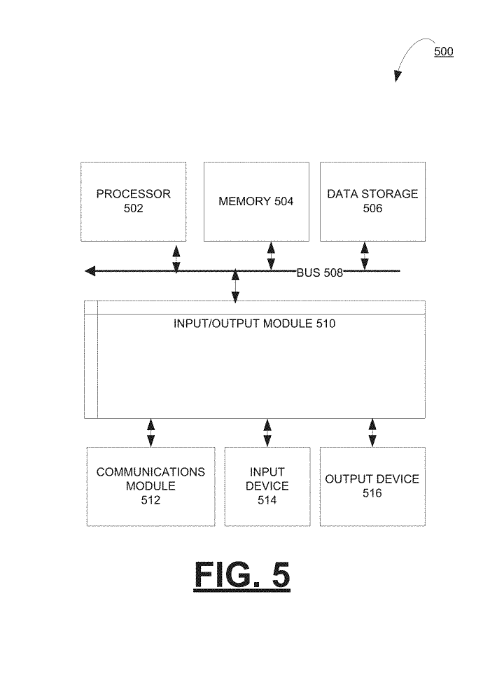

FIG. 5 is a block diagram illustrating an example computer system 500 with which the client 110A, client 110B, and server 130 of FIG. 2 can be implemented. In certain aspects, the computer system 500 may be implemented using hardware or a combination of software and hardware, either in a dedicated server, or integrated into another entity, or distributed across multiple entities.

Computer system 500 (e.g., client 110A, client 110B, and server 130) includes a bus 508 or other communication mechanism for communicating information, and a processor 502 (e.g., processor 212, 252, 236) coupled with bus 508 for processing information. According to one aspect, the computer system 500 can be a cloud computing server of an IaaS that is able to support PaaS and SaaS services. According to one aspect, the computer system 500 is implemented as one or more special-purpose computing devices. The special-purpose computing device may be hard-wired to perform the disclosed techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices, or any other device that incorporates hard-wired and/or program logic to implement the techniques. By way of example, the computer system 500 may be implemented with one or more processors 502. Processor 502 may be a general-purpose microprocessor, a microcontroller, a Digital Signal Processor (DSP), an ASIC, a FPGA, a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memory 220, 260, and 240), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry. Expansion memory may also be provided and connected to computer system 500 through input/output module 510, which may include, for example, a SIMM (Single In Line Memory Module) card interface. Such expansion memory may provide extra storage space for computer system 500, or may also store applications or other information for computer system 500. Specifically, expansion memory may include instructions to carry out or supplement the processes described above, and may include secure information also. Thus, for example, expansion memory may be provided as a security module for computer system 500, and may be programmed with instructions that permit secure use of computer system 500. In addition, secure applications may be provided via the SIMM cards, along with additional information, such as placing identifying information on the SIMM card in a non-hackable manner.

The instructions may be stored in the memory 504 and implemented in one or more computer program products, e.g., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices (e.g., input device 216, display device 214). The input/output module 510 can be any input/output module. Example input/output modules 510 include data ports such as USB ports. In addition, input/output module 510 may be provided in communication with processor 502, so as to enable near area communication of computer system 500 with other devices. The input/output module 510 may provide, for example, wired communication in some implementations, or wireless communication in other implementations, and multiple interfaces may also be used. The input/output module 510 is configured to connect to a communications module 512. Example communications modules 512 (e.g., communications module 218, 258, and 238) include networking interface cards, such as Ethernet cards and modems.

The components of the system can be interconnected by any form or medium of digital data communication (e.g., a communication network). The communication network (e.g., communication network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

For example, in certain aspects, communications module 512 can provide a two-way data communication coupling to a network link that is connected to a local network. Wireless links and wireless communication may also be implemented. Wireless communication may be provided under various modes or protocols, such as GSM (Global System for Mobile Communications), Short Message Service (SMS), Enhanced Messaging Service (EMS), or Multimedia Messaging Service (MMS) messaging, CDMA (Code Division Multiple Access), Time division multiple access (TDMA), Personal Digital Cellular (PDC), Wideband CDMA, General Packet Radio Service (GPRS), or LTE (Long-Term Evolution), among others. Such communication may occur, for example, through a radio-frequency transceiver. In addition, short-range communication may occur, such as using a BLUETOOTH, WI-FI, or other such transceiver.

In any such implementation, communications module 512 sends and receives electrical, electromagnetic, or optical signals that carry digital data streams representing various types of information. The network link typically provides data communication through one or more networks to other data devices. For example, the network link of the communications module 512 may provide a connection through local network to a host computer or to data equipment operated by an Internet Service Provider (ISP). The ISP in turn provides data communication services through the world wide packet data communication network now commonly referred to as the “Internet.” The local network and Internet both use electrical, electromagnetic, or optical signals that carry digital data streams. The signals through the various networks and the signals on the network link and through communications module 512, which carry the digital data to and from computer system 500, are example forms of transmission media.

Computer system 500 can send messages and receive data, including program code, through the network(s), the network link, and communications module 512. In the Internet example, a server might transmit a requested code for an application program through the Internet, the ISP, the local network, and communications module 512. The received code may be executed by processor 502 as it is received, and/or stored in data storage 506 for later execution.

In certain aspects, the input/output module 510 is configured to connect to a plurality of devices, such as an input device 514 (e.g., input device 216) and/or an output device 516 (e.g., display device 214). Example input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Example output devices 516 include display devices, such as an LED (light emitting diode), CRT (cathode ray tube), LCD (liquid crystal display) screen, a TFT LCD (Thin-Film-Transistor Liquid Crystal Display) or an OLED (Organic Light Emitting Diode) display, for displaying information to the user. The output device 516 may comprise appropriate circuitry for driving the output device 516 to present graphical and other information to a user.

According to one aspect of the present disclosure, the client 110A can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. Processor 502 may process the executable instructions and/or data structures by remotely accessing the computer program product, for example by downloading the executable instructions and/or data structures from a remote server through communications module 512 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects, a user of systems and methods as disclosed herein may perform at least some of the steps by accessing a cloud server through a network connection. Further, data files, circuit diagrams, performance specifications, and the like resulting from the disclosure may be stored in a database server in the cloud-computing environment, or may be downloaded to a private storage device from the cloud-computing environment.

Computing system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer-readable medium” as used herein refers to any medium or media that participates in providing instructions or data to processor 502 for execution. The term “storage medium” as used herein refers to any non-transitory media that store data and/or instructions that cause a machine to operate in a specific fashion. Such a medium may take many forms, including, but not limited to, non-volatile media, volatile media, and transmission media. Non-volatile media include, for example, optical disks, magnetic disks, or flash memory, such as data storage device 506. Volatile media include dynamic memory, such as memory 504. Transmission media include coaxial cables, copper wire, and fiber optics, including the wires that comprise bus 508. Common forms of machine-readable media include, for example, a floppy disk, a flexible disk, a hard disk, magnetic tape, any other magnetic medium, a CD-ROM, a DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire, and fiber optics, including the wires that comprise bus 508. Transmission media can also take the form of acoustic or light waves, such as those generated during radio-wave and infra-red data communications. Furthermore, as used in this specification of this application, the terms “computer,” “server,” “processor,” and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first, second, and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately, or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method for improving resource utilization of electronic healthcare systems by providing health trend analysis and inspection, the method comprising:
detecting a presence of a user;
determining that a threshold time period has elapsed;
retrieving, from a server, a health query customized for the user based on a patient data store associated with the user;
prompting the user to provide a response to the health query;
storing the response to the health query and an associated timestamp in a secure package; and
uploading the secure package to the server via an available network connection to cause the server to:
store the response to the health query and the associated timestamp in the patient data store associated with the user; and
perform an action based on one or more analysis algorithms applied on the patient data store associated with the user.

2. The method of claim 1, wherein the determining that the threshold time period has elapsed comprises:
querying the server for a most recent health query response time from one or more devices associated with the user; and
determining that an elapsed time from the most recent health query response time exceeds the threshold time period.

3. The method of claim 1, wherein the health query comprises an instruction to capture a body area of the user via an imaging device, and wherein the one or more analysis algorithms operate on a plurality of images of the body area of the user.

4. The method of claim 1, wherein the detecting the presence of the user comprises:
capturing an image via an imaging device; and
determining that the user is present in the image.

5. The method of claim 1, wherein the detecting the presence of the user comprises:
detecting a plurality of user inputs within a time period; and
determining that the plurality of user inputs exceeds an idle threshold.

6. The method of claim 1, wherein the health query comprises an open ended wellness query that does not comprise a multiple choice question.

7. The method of claim 1, wherein the threshold time period does not exceed one week.

8. The method of claim 1, wherein the one or more analysis algorithms further utilize patient data stores associated with other users.

9. The method of claim 1, wherein the action comprises storing a flag in the patient data store associated with the user, wherein the flag indicates a match to a particular diagnosis.

10. The method of claim 1, wherein the action comprises one of:
sending an alert to a healthcare provider associated with the user; or
sending a notification to a device associated with the user.

11. The method of claim 1, wherein the uploading further causes the server to, prior to the performing the action:
determine that an updated diagnostic profile is available for the one or more analysis algorithms; and
update the one or more analysis algorithms based on the updated diagnostic profile.

12. The method of claim 1, wherein prior to storing the response to the health query and the associated timestamp in the secure package, the method further comprises:
filtering the response to the health query to remove information that is duplicative or irrelevant to the health query.

13. The method of claim 1, wherein the uploading further causes the server to categorize the response to the health query based on a comparison with prior responses stored in the patient data store associated with the user.

14. The method of claim 1, wherein the uploading further causes the server to categorize the response to the health query based on a comparison to a database using keyword matching or natural language processing.

15. The method of claim 1, wherein the secure package and the patient data store associated with the user are each encrypted.

16. The method of claim 1, wherein prior to storing the response to the health query and the associated timestamp in the secure package, the method further comprises:
receiving user input comprising one of speech, text, or handwriting; and
parsing the user input to generate the response to the health query.

17. A system for improving resource utilization of electronic healthcare systems by providing health trend analysis and inspection, the system comprising:
a memory; and
a processor configured to execute instructions which, when executed, cause the processor to:
detect a presence of a user;
query a server for a most recent health query response time from one or more devices associated with the user;
determine that an elapsed time from the most recent health query response time exceeds a threshold time period;
retrieve, from a server, a health query customized for the user based on a patient data store associated with the user;
prompt the user to provide a response to the health query;
receive user input comprising one of speech, text, or handwriting;
parse the user input to generate the response to the health query;
store the response to the health query and an associated timestamp in a secure package; and
upload the secure package to the server via an available network connection to cause the server to:
store the response to the health query and the associated timestamp in the patient data store associated with the user; and
perform an action based on one or more analysis algorithms applied on the patient data store associated with the user.

18. The system of claim 17, wherein the health query comprises an instruction to capture a body area of the user via an imaging device, and wherein the one or more analysis algorithms operate on a plurality of images of the body area of the user.

19. The system of claim 17, wherein the processor is further configured to upload the secure package to cause the server to, prior to the performing the action:
determine that an updated diagnostic profile is available for the one or more analysis algorithms; and
update the one or more analysis algorithms based on the updated diagnostic profile.

20. A non-transitory machine-readable storage medium comprising machine-readable instructions for causing a processor to execute a method for improving resource utilization of electronic healthcare systems by providing health trend analysis and inspection, comprising:
detecting a presence of a user;
querying a server for a most recent health query response time from one or more devices associated with the user;
determining that an elapsed time from the most recent health query response time exceeds a threshold time period;
retrieving, from a server, a health query customized for the user based on a patient data store associated with the user;
prompting the user to provide a response to the health query;
receiving user input comprising one of speech, text, or handwriting;
parsing the user input to generate the response to the health query;
storing the response to the health query and an associated timestamp in a secure package; and
uploading the secure package to the server via an available network connection to cause the server to:
store the response to the health query and the associated timestamp in the patient data store associated with the user;
determine that an updated diagnostic profile is available for one or more analysis algorithms;
update the one or more analysis algorithms based on the updated diagnostic profile; and
perform an action based on the one or more analysis algorithms applied on the patient data store associated with the user.
